(19) United States
(12) Patent Application Publication
(10) Pub. No.: US 2006/0272174 A1
(43) Pub. Date: Dec. 7, 2006

(54) Deposition chamber desiccation systems and methods of use thereof

(76) Inventor: Klaus Hartig, Avoca, WI (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/437,429

(22) Filed: May 19, 2006

Related U.S. Application Data
(60) Provisional application No. 60/682,986, filed on May 20, 2005.

(51) Int. Cl. F26B 21/08

(52) U.S. Cl. 34/475; 34/218; 34/80

(57) ABSTRACT

The present invention provides a system and method for removing contaminating moisture from a deposition chamber prior to use. Dry air, preferably hot dry air, is blown into the deposition chamber where it absorbs and removes moisture. This is done by connecting a desiccation system including a blower and a dryer to the deposition chamber. The deposition chamber is also provided with a vacuum source; this may be connected to the deposition chamber using the same line as that used for the desiccation source, or may be connected through a separate line. The dry air may re-circulate through the chamber during this flushing method, or the dry air may flow through the deposition chamber continuously. A heat exchanger may also be provided to efficiently reuse hot air used to recharge the desiccation system. The desiccation system and method are particularly suited for decontaminating a magnetron sputtering deposition chamber.

### RELATED APPLICATION

The present application claims priority to U.S. provisional patent application 60/682,986, filed May 20, 2005, the entire disclosure of which is incorporated herein by reference.

### FIELD OF THE INVENTION

The present invention is related to a system and methods for drying a deposition chamber by flushing it with desiccated air. In various embodiments of the present invention, the desiccated air may also be heated to enhance the drying of the chamber. In particular, these systems and methods are useful for rapidly decontaminating and/or drying a magnetron sputtering deposition chamber prior to evacuation for thin film deposition.

### BACKGROUND OF THE INVENTION

The present invention relates to systems and methods for desiccating deposition chambers that are used to run processes sensitive to the presence of moisture. Chemical and physical deposition processes such as chemical vapor deposition, plasma enhanced chemical vapor deposition, magnetron sputtering, and E-beam evaporation can be utilized for the formation of thin films on substrates. These films can be important for numerous devices, such as semiconductors and window glass. Typical films created by these processes include metallic materials such as silver, aluminum, gold, and tungsten, or dielectric materials such as zinc oxide, titanium oxide, silicon oxide and silicon nitride.

As previously suggested, magnetron sputtering is one means of producing thin films of metallic material. Magnetron sputtering involves providing a target including or formed of a metal or dielectric, and exposing this target to a plasma in a deposition chamber thereby sputtering off the metal or dielectric material from the target and depositing it on a substrate. Generally, this process is performed by applying a negative charge to the target and positioning a relatively positively charged anode adjacent to the target. By introducing a relatively small amount of a desired gas into the chamber adjacent to the target, a plasma can be established. Upon generation of the plasma, atoms within the plasma collide with the target, knocking atoms or molecules of metal or dielectric material off of the target and sputtering them onto the substrate to be coated. Additionally, it is also known in the art to include one or more magnets behind the target to help shape the plasma and focus the plasma in an area adjacent the surface of the target.

The properties of thin films are attributed to a combination of the properties of the materials used to create the film and surface and/or interfacial effects between the film and the substrate upon which it is placed. As film thickness is reduced, surface/interface effects become increasingly important. Surface/interface effects are strongly influenced by the cleanliness of the surface and the ambient environment within the deposition chamber at the initiation of the deposition cycle. Thus, in order to produce high quality thin films, it is necessary to keep the deposition chamber as clean as possible.

A major contaminant typically found on nearly all of the surfaces within a deposition chamber is water, which is generally deposited on chamber surfaces by precipitation from moisture in the environment. Water vapor is a significant component of the atmosphere, and may occupy as much as 2.5% of air by volume at room temperature. Water is known to collect in deposition chambers upon opening of the chambers for cleaning. Allowing the water to remain in the chamber is likely to reduce the quality of thin films produced. Water is difficult to remove because of the strong bonding interaction between polar water molecules and the surfaces of the chamber and substrate. Furthermore, hydrogen bonding between the water molecules themselves can cause the water to accumulate in layers, contributing to higher levels of contamination.

At the initiation of the deposition cycle, water on the surface of the substrate and the deposition chamber may come in direct contact with the materials being deposited, and in certain instances may react with these materials. In the case of metallic source materials, these reactions generally produce metal oxides. Additionally, water generally causes corrosion of sputtered films and glass surfaces. Furthermore, water-related impurities are typically concentrated at the interface, and make it difficult to etch selectively or deposit a high quality film. Also, water-related impurities impair adhesion and electric contact, add to the stress of the film, and generally result in a variety of film quality problems.

Undeposited water vapor within the chamber can cause additional problems in vapor deposition systems, such as low pressure chemical vapor deposition systems or a plasma-enhanced vapor deposition systems. The metallic source materials used in these systems are typically halides of the metal being deposited. These halides are highly reactive with water, and form oily residues which adhere to surfaces and further react with water on exposure to regular atmosphere. Therefore, the consequences of contamination by water can be particularly severe in vapor deposition systems.

The potential damage to products that may be caused by moisture present in a deposition chamber is well known in the art, and various procedures have been developed to reduce such damage by removing moisture prior to material deposition. One water removal process involves injecting a volatile organo halosilane such as trimethylchlorosilane into a reaction chamber. Another procedure involves creating a very low pressure inside the chamber (generally about 1-25 milliTorr), followed by decontamination of the chamber using a non-contaminating gas such as argon at low pressure (e.g. 200 milliTorr). These two steps are referred to as “pumping” and “purging”, respectively. A single cycle of this process can take over an hour, and in some situations a repeated series of pumpings and purgings is required to reach the level of desiccation necessary.

Another approach for desiccating deposition chambers is simply to evacuate the chamber by applying a vacuum for an extended period. The initial application of vacuum to the chamber will remove water, but the rate of water removal will gradually slow due to a reduction in temperature that steadily occurs with extended vacuum application. This is partially due to the reduction in temperature caused by the water evaporation. Providing additional heat during the application of vacuum to the chamber may assist in water removal, but this does not completely counter the water's tendency to adhere to the surfaces of the deposition chamber. Therefore, the removal of water remains difficult even when both vacuum and heat are administered to the chamber. In general, the time and expense involved in conducting the processes described above makes them less than ideal for the efficient desiccation of deposition chambers.

### SUMMARY OF THE INVENTION

To rapidly and inexpensively dry a deposition chamber, the present invention provides a system and method in which a deposition chamber is flushed with dry air to remove contaminating moisture prior to use. The deposition chamber is preferably part of a magnetron sputtering system. However, any chamber utilized in deposition processes may be used in conjunction with the desiccation system described in the present invention. Dry air, preferably hot dry air, is delivered at or above atmospheric pressure in order to flush the chamber of moisture. Following this flushing step, the deposition chamber is typically evacuated by applying a vacuum prior to use. Flushing with dry air desiccates the chamber much more rapidly than the traditional pump-down technique. Furthermore, it is easier, faster, and less expensive to provide desiccated air at high pressure to dry the chamber than it is to provide vacuum and maintain a reaction chamber at low pressure. Thus, the present invention provides a more rapid and less expensive means of desiccating a deposition chamber.

The system of the present invention generally includes a desiccation system coupled with a blower for delivering desiccated air to a deposition chamber. Preferably, the dry air is heated, either through the action of the desiccation system or the operation of one or more heaters. In one embodiment, the line connecting the desiccation system and the blower to the deposition chamber is coextensive with the one leading to the vacuum source. When using this embodiment, at the conclusion of drying, the administered dry air is removed by evacuating the chamber, drawing off the captured moisture thereby resulting in a desiccated chamber. Alternately, the vacuum source may be configured to draw a vacuum directly through the desiccation system. In an alternate embodiment, the vacuum source is provided with a separate line from that leading to the desiccation system. This embodiment allows air to be withdrawn along the vacuum source line, which enables dry air to flow through the deposition chamber continuously during flushing. Similar to this arrangement, the drying apparatus may be integrally incorporated into a sputtering line thereby allowing air to be recirculated through a closed chamber during flushing to encourage all the moisture present to evaporate and subsequently be removed from the chamber.

The present invention also includes a method for drying a deposition chamber that includes the steps of passing air through a desiccation system, blowing the dried air into a deposition chamber at or above atmospheric pressure, and withdrawing air from the deposition chamber after it has absorbed all or a portion of the moisture present within the chamber. Optionally, the air blown into the deposition chamber may be heated. The air is preferably dried using either refrigerator condensation, desiccant dehumidifiers, membrane dryers, or in-line filtration systems, and may preferably be dried to below −20° F. dew point or less, with a dew point of −55° F. being particularly preferred. Air that is this dry, particularly if heated, is capable of removing substantially all of the moisture within a deposition chamber within a short amount of time.

### BRIEF DESCRIPTION OF THE DRAWINGS

FIG. 1 is a schematic cross-sectional view of a magnetron sputtering system modified by addition of a blower and a desiccation system using the same line as that used to connect the vacuum source;

FIG. 2 is a schematic cross-sectional illustration of a magnetron sputtering system modified by addition of a blower and desiccation system along a line separate from that used for the vacuum source;

FIG. 3 is a schematic cross-sectional illustration of a deposition system provided with a desiccation system;

FIG. 4 is a side view of an embodiment of a desiccation system that may be used to dry a deposition system; and

FIG. 5 is schematic cross-sectional illustration of a deposition system and desiccation system provided with a heat exchange system, according to an embodiment of the present invention.

### DETAILED DESCRIPTION OF THE INVENTION

To better illustrate the invention, the preferred embodiments will now be described in more detail. Reference will be made to the drawings, which are summarized above. Reference numerals will be used to indicate parts and locations in the drawings. The same reference numerals will be used to indicate the same parts of locations throughout the drawing unless otherwise indicated.

The present invention provides a system and method in which contaminating moisture within a deposition chamber is removed prior to use by flushing the deposition chamber with dry air. The deposition chamber is preferably part of a magnetron sputtering system. However, the described system and method of drying may also be used for non-magnetic sputtering deposition chambers. Dry air, preferably hot dry air, is delivered from a desiccation system through delivery lines at or above atmospheric pressure in order to flush the chamber of moisture. The deposition chamber and the drying apparatus used for desiccation of the chamber are described, in turn, below.

While the desiccation system of the present invention can be used in conjunction with a variety of deposition systems, a magnetron sputtering system will be used herein to provide a detailed example. Sputtering techniques and equipment utilized in magnetron sputtering systems are well known in the art. For example, magnetron sputtering chambers and related equipment are available commercially from a variety of sources (e.g., Leybold and BOC Coating Technology). Examples of useful magnetron sputtering techniques and equipment are also disclosed in the references such as U.S. Pat. No. 4,166,018, issued to Chapin, the teachings of which are incorporated herein by reference. The magnetron sputtering process usually occurs in a deposition chamber 10 within a controlled atmosphere under low pressure conditions. The deposition chamber 10 is generally constructed with metallic walls, typically made of steel or stainless steel, operably assembled to form a chamber that can maintain a low pressure environment during sputtering.

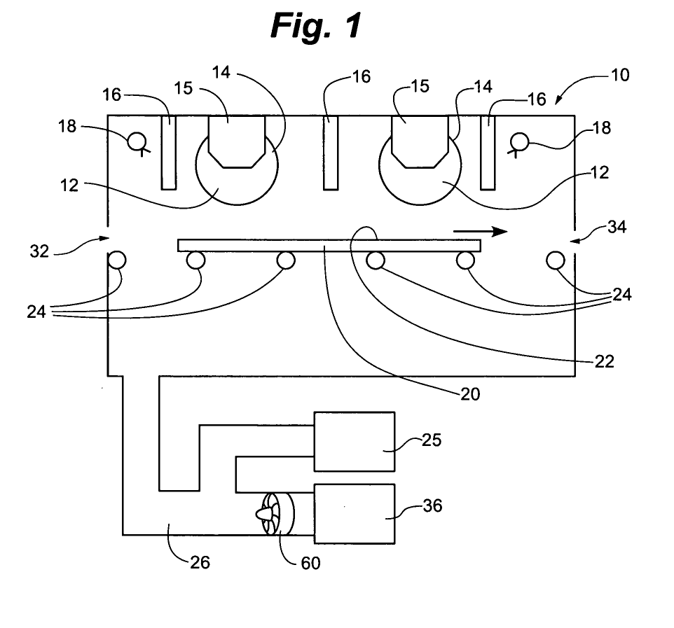

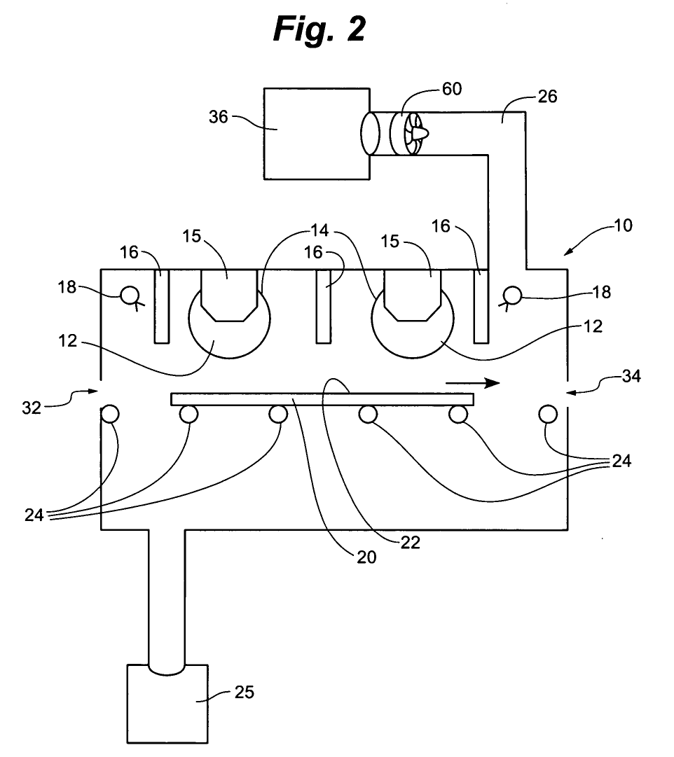

FIGS. 1 and 2 illustrate two embodiments of the present invention that differ in how the vacuum source 25 and desiccation system 36 are connected to the deposition chamber 10. In both embodiments, the desiccation system 36 is provided with a main blower 60 which serves to propel the air. FIG. 1 illustrates the embodiment in which the desiccation system 36 is connected to the deposition chamber 10 using the same line as that used by the vacuum source 25. This has the advantage of simplifying construction, and minimizing possible leakage and maintenance requirements. FIG. 2 illustrates the embodiment in which the desiccation system 36 is connected to the deposition chamber 10 by a separate line from that used for the vacuum source 25. The embodiment illustrated in FIG. 2 has the advantage of being more conducive to creating an air flow from the dry air source to the vacuum source, which can serve as a dry air outlet within the deposition chamber 10. Continuous air flow has the advantage of maintaining a very low moisture level of the air within the deposition chamber, which generally results in more rapid drying rates. Within or partially within the deposition chamber 10 is a cathode assembly 14, as depicted in FIGS. 1 and 2. Generally, a sputtering system comprises a deposition chamber 10 defining a controlled environment, a cathode assembly 14, one or more power sources supplying cathodic and anodic charge (not shown), and one or more gas distribution outlets 18. The deposition chamber 10 also uses shield assemblies 16 that isolate the targets 12, and rollers 24 that support and transport a substrate 20 that is being processed through the chamber 10. The cathode assembly 14 generally comprises one or more cylindrical targets 12, one or more motor assemblies 15, and optional magnet assemblies (not shown).

Cylindrical targets 12 are usually held in a manner suitable to allow rotation about their longitudinal axes. Although a cylindrical target 12 is illustrated in FIG. 1, it is noted that planar targets with adjacent magnet assemblies may also be utilized in the present invention. Generally, the cylindrical target 12 includes a tubular backing formed of electrically conductive material, such as stainless steel, aluminum, or any other suitably conductive material. In such embodiments, the outer surface of the tubular backing of the cylindrical target 12 is usually coated with one or more target materials that are intended to be sputtered onto a substrate 20 during operation of the sputtering chamber. Although only two cathode assemblies 14 are illustrated in FIGS. 1 and 2, use of one or several cathode assemblies 14 within a single deposition chamber 10 is contemplated for the present invention. The sputterable target materials may include, but are not limited to, materials such as silicon, zinc, tin, silver, gold, aluminum, copper, titanium, niobium, zirconium or combinations thereof. Target materials may also be reacted with a reactive gas, such as oxygen or nitrogen, to form dielectric coatings such as zinc oxide, silicon nitride, titanium dioxide, silicon carbide or the like.

The cathode assembly 14 further includes one or more motor assemblies 15 for supporting and rotating the cylindrical targets 12. One or more motor assemblies 15 are operably connected to each cylindrical target 12 by any clamping or bracketing means (not shown). The clamping or bracketing device may be any type of clamp, bracket, frame, fastener or support that retains the cylindrical target 12 in position while allowing for its rotation by the motor assembly 15. Each motor assembly 15 generally includes a motor source, a power source, and a control system. Examples of motor sources useful in a motor assembly 15 of the present invention include, but are not limited to, programmable stepper motors, electric motors, hydraulic motors and/or pneumatic motors. Examples of power sources include any type of power source that can provide a potential of approximately 0.1-5 kV with a current equal to at least 0.1-10 mA/cm² of the target surface area. Finally, the control system of the motor assembly 15 functions to activate the motor source and control the rotational speed of a cylindrical target 12.

A deposition chamber 10 also generally includes an entry point 32 and an exit point 34 to allow the substrate 20 to enter and exit the chamber during continuous operation. Substrate 20 and support rollers 24 are also shown. Substrate 20 rests upon the support rollers 24 and is brought into deposition chamber 10 through the entry point 32 in the chamber. The support rollers 24 transport the substrate 20 through the chamber, and are maintained at a speed that retains the substrate within the chamber for a time sufficient to achieve the desired coating thickness of sputtered material. Once the substrate 20 has been coated with a thin layer 22 of material, it exits the deposition chamber 10 through an exit point 34.

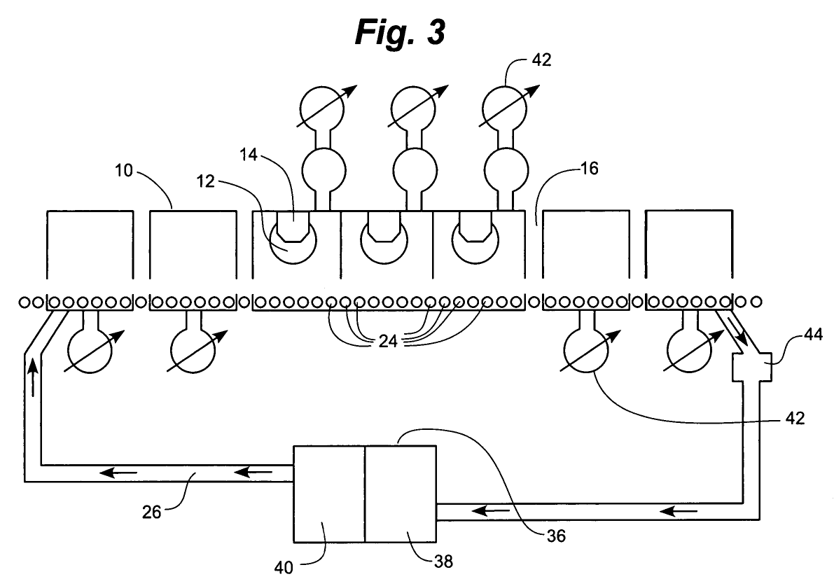

FIG. 3 depicts an overall schematic view of a deposition system provided with a desiccation system 36. The figure shows a desiccation system 36 operably adjoined to the magnetron sputtering chamber 10 by means of a dry air distribution line 26. The magnetron sputtering chamber 10 contains the various components described earlier in FIGS. 1 and 2, such as cathode assemblies 14, shield assemblies 16, and rollers 24 to support and transport the substrate 20 during deposition. The magnetron sputtering chamber 10 is also preferably provided with one or more vacuum pumps 42 that remove air or other gases from the chamber, creating an environment suitable for sputtering. The desiccation system 36 preferably comprises one or more drying devices that desiccate gases passed through them. In a preferred embodiment, the desiccation system 36 comprises a cooling system 38 and a dehumidifier 40. The dry air distribution line 26 may include a humidity indicator 44 that indicates the moisture level of the air at that point in the distribution line 26. Preferably, the humidity indicator 44 is positioned at a point near where air exits from the sputtering chamber 10 so that the approximate moisture level within the sputtering chamber may be known.

Various desiccation systems 36 can be used to dry air for use in desiccating a deposition chamber 10. Desiccation systems 36 may use refrigeration, in which water vapor precipitates as a result of a drop in temperature and is removed; desiccants, in which water is adsorbed by a generally granular material such as activated alumina, silica gel, or molecular sieves; membranes, where compressed air flows through a bundle of membranes and water is isolated through membrane action; or other in-line filtration systems where water is segregated and then drained off. Note that these desiccation systems 36 frequently remove other contaminants such as oils in addition to dehydrating the air. For example, the Devair™ FDP25 removes solid particles to 0.01 micron, and removes 99.99+% of oil aerosols. The desiccation system 36, regardless of type, is operably connected to the dry air distribution line 26 in such a fashion that it provides dried air for the deposition chamber 10 during the drying procedure, as shown in FIG. 3. Air which has a moisture level lower than that of the ambient atmosphere may be considered dry, but air which has been desiccated to −20° F. dew point is preferred. Most preferably, air which has been desiccated to −55° F. dew point or less is used.

Prior to use, the deposition chamber 10 is desiccated by flushing it with dry air provided by the desiccation system 36. Air, as defined for use in the present invention, is ambient atmospheric gas composed of approximately 78% nitrogen, 21% oxygen, and 1% argon, with a variety of trace compounds such as carbon dioxide and neon. Other gas mixtures capable of absorbing moisture would also be suitable for use in the present invention, though they are unlikely to be as readily available as ambient atmosphere. Air may be provided by any source, such as pressurized containers or simply from the local atmosphere. Dried air is supplied to the deposition chamber at one or more locations, preferably at slightly above atmospheric pressure. In addition to air, two other components are needed for the present invention; namely, a means for drying the air and a means for moving the air. Preferably, the dry air is heated as well, requiring the presence of a heat source capable of imparting heat into the air.

In order to move air into the deposition chamber 10, a main blower 60 is typically used, though if a sufficiently pressurized air source is used a blower may not be necessary. A variety of blowers are available, such as vane axial fan blowers or centrifugal blowers, that are suitable for use in the present invention. The main blower 60 is operably connected to dry air distribution line 26 so that dry air may be rapidly delivered from the desiccation system 36 to the deposition chamber 10 during the drying procedure. It may either be placed adjoining the vacuum line, or may be connected through an independent line. The main blower 60 may be positioned on either side of the dryer within the dry air distribution line 26, but is preferably located where it can draw air from the desiccation system 36 rather than blowing air into it. Preferably, the main blower 60 blows dried air into the deposition chamber 10 at a rate of 500 scfm or more.

In a preferred embodiment of the present invention, the dry air provided by the desiccation system 36 is heated. As noted, hot air is preferred as it more readily removes water from interior surfaces within the deposition chamber 10. Hot dry air, according the present invention, is air which has been heated above room temperature; i.e. above 75° F. Preferably, the air is heated to a temperature of about 90° F. to about 150° F. Air may be heated as part of the dehumidification process. Alternately, or in addition, one or more heaters (not shown) may be placed anywhere along the dry air distribution line 26 in order to heat the air before it reaches the deposition chamber 10.

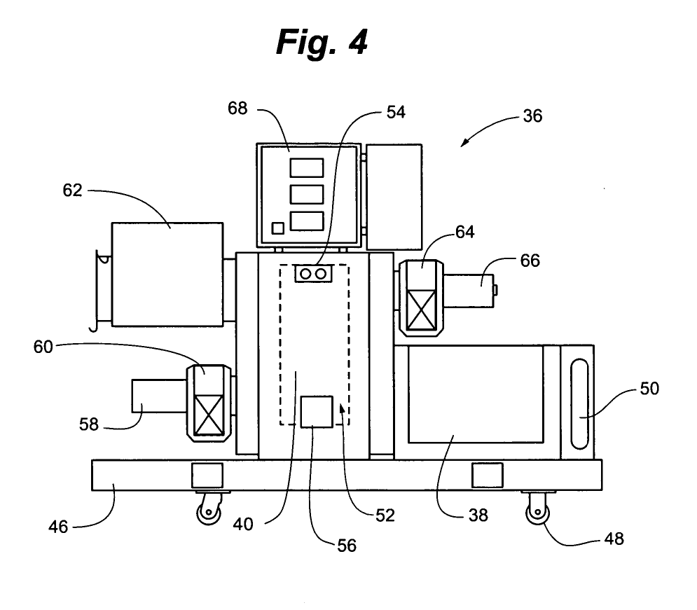

An embodiment of a desiccation system 36 that may be utilized in the present invention is illustrated in FIG. 4, which shows a side view of a desiccation system 36 that includes both a cooling system 38 and a dehumidifier 40. These two systems, as well as other components of the desiccation system 36, may be mounted on skids 46. The skids 46 may be further supplied with wheels 48 in order to facilitate moving the desiccation system 36. Preferred airflow values within the dry air distribution line 26 of the desiccation system 36 are from about 500 to 1000 standard cubic feet per minute (scfm).

The desiccation system 36 shown in FIG. 4 operates in the following fashion. Air from the deposition chamber 10 enters the desiccation system 36 through filter chamber 50 to remove potentially damaging particulate matter. An example of a filter that may be used in this capacity is a high-efficiency disposable filter with 30% efficiency. After being filtered, air then enters the cooling system 38 where it is cooled and dried by refrigeration. In one embodiment, the cooling system 38 is a cold-water cooling system that uses chilled water run through coils within the apparatus. Upon cooling, water precipitates from the air and is then withdrawn from the cooling system 38. In a preferred embodiment of the cooling system 38, water at a temperature of about 6° F. is used, and the air drops from about 150° F. to about 90° F. after passing through the cooling system 38, resulting in dehumidification of about 35 Lbs/Hr at a rate of 700 scfm.

After passing through the cooling system 38, air enters the dehumidifier 40 where further moisture is removed. The dehumidifier 40 operates by absorbing water at one end, transporting the water to the other end of the dehumidifier 40, and then releasing the water into a different airstream by exposure to hot, dry air which evaporates and carries off the moisture. In one embodiment of the present invention, this may be accomplished utilizing a dehumidifying disc 52, seen from the side within FIG. 4. The dehumidifying disc 52 is a rotary structure comprising a desiccant material held within an annular casing made of a light and durable material such as aluminum. The rotary structure rotates around its center when in operation, moving desiccant material that has absorbed water from the main air stream up to a heated region where moisture is released into the reactivation air stream. In one embodiment, the dehumidifying disc 52 is rotated using a self-tensioning drive belt arrangement. Preferably, the desiccant material utilized in the dehumidifying disc 52 is an inert, non-corrosive solid. Examples of desiccant material suitable for use in the dehumidifier 40 include lithium chloride, titanium silica gel, molecular sieves, and Cargocaire's™ proprietary desiccant HPX. The dehumidifier 40 may be provided with air flow gauges 54 to monitor airflow within the apparatus, as well as an inspection window 56. In a preferred embodiment, dehumidification of about 20 Lbs/Hr is achieved at a rate of 700 scfm, resulting in a total dehumidification of about 55 Lbs/Hr when the dehumidification resulting from operation of the cooling system 38 and the dehumidifier 40 are combined. Dehumidification at this rate can produce air with a dew point of −55° F. or less. The air temperature is substantially higher upon leaving the dehumidifier 40 as a result of exposure to heated air. The dry air leaves through a main air outlet 58, accelerated by an enclosed main blower 60. A preferred main blower 60 is a centrifugal, direct drive fan with a speed of 3450 rpms and a power of 2 horsepower, resulting in an airflow rate of about 700 scfm. In one embodiment, air leaving the desiccation system 36 has a temperature of about 110° F.

The dehumidifier 40 described above utilizes a reactivation system that reactivates the desiccant within the dehumidifying disc 52 by evaporating off moisture, readying the desiccant to re-absorb moisture when that portion of the dehumidifying disc 52 rotates back into the main air stream. The reactivation system includes a heater 62 that heats the air in the reactivation air stream to a temperature sufficient to reactivate the desiccant. The heater 62 may be, for example, an electric, steam, or gas-driven heater, or any other energy system capable of efficiently warming air. For example, in one embodiment, the heater 62 is an electric heater that heats the air to a temperature of about 250° F. Hot air enters one end of the dehumidifier 40, and reactivates desiccant on the dehumidifying disc 52. The side of the dehumidifier 40 in which reactivation occurs is separated from the side in which moisture is removed from the air by a contact air seal (not shown) in order to minimize mixing of the separate air streams. Moist, hot air is withdrawn from the dehumidifier 40 into the reactivation air stream by a reactivation blower 64, propelling it outwards through a reactivation air outlet 66. The reactivation air stream is generally smaller than the main air stream, and hence a reactivation blower 64 may be used that has a lower air flow rate (in scfm) than the main blower 60. For example, in one embodiment, the reactivation blower 64 is a centrifugal, direct drive fan with a speed of 3450 rpms and a power of 1 horsepower, resulting in an airflow rate of about 300 scfm.

The desiccation system 36 preferably includes a desiccation control console 68, that may include, for example, motor starters, overload protective devices, microprocessors with indicator lights, and fault circuits. The desiccation control console 68 may be used to regulate the automatic continuous operation of the desiccation system 36.

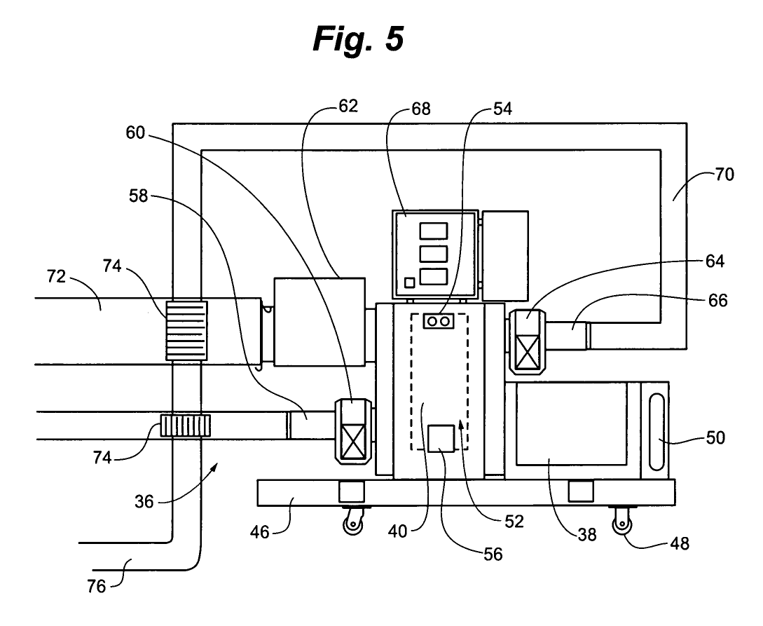

An alternate embodiment of the present invention utilizes the hot, moist air that is expelled through reactivation air outlet 66 to pre-heat the air that exits the desiccation system 36 through the main air outlet 58, and/or to pre-heat the air that enters the heater 62. By pre-heating the air exiting the main air outlet 58, the desiccation system 36 is able to operate more efficiently by re-utilizing heat that would otherwise be wasted as exhaust. Similarly, by pre-heating the air entering the heater 62, the reactivation system is able to operate more efficiently by re-utilizing heat that would otherwise be wasted as exhaust. An illustration of this embodiment is shown in FIG. 5, which shows a deposition and desiccation system provided with a heat exchange system. In this embodiment, hot, moist air leaves the reactivation outlet 66 and enters the recycling line 70, where it is directed back to either or both of the main air outlet 58 and reactivation input line 72. The air from the recycling line 70 is run past the air flowing in the main air outlet 58 and/or the reactivation input line 72 using air-to-air heat exchangers 74. FIG. 5 illustrates an embodiment of the invention where heat exchangers 74 are placed in both the main air outlet 58 and reactivation input line 72 in a series arrangement. Various embodiments of the invention may optionally reverse the order of the heat exchangers 74, or may provide a parallel arrangement of the heat exchangers 74, or may provide a single heat exchanger 74 located in either the main air outlet 58 or the reactivation input line 72. Highly conductive metal or other materials within the heat exchangers 74 remove the heat energy from the hot, moist air in the recycling line 70 and transfers it to the cooler air exiting the main air outlet 58 and/or entering through the reactivation input line 72. A variety of configurations may be used for the air-to-air heat exchanger 74, as would be recognized by one of ordinary skill in the art. Since the air within the lines does not actually mix, the relatively dry air flowing from the main air outlet 58 and into the reactivation input line 72 is not contaminated by the moisture present in the relatively humid air in the recycling line 70. After passing through the heat exchangers 74, the remaining humid air is removed from the system by means of an exhaust line 76.

In operation, a magnetron sputtering system with a deposition chamber 10 can be used to deposit one or more coatings upon one or more substrates 20 by sputtering target material from the cylindrical target 12. After desiccation of the deposition chamber 10 using the desiccation system 36, as described above, sputtering is generally initiated by pumping down or evacuating the deposition chamber 10 using vacuum suction. Normally, the chamber is pumped down to approximately 10⁻⁵ Pa or less. Next, an inert gas, typically argon, flows into chamber 10 through the gas distribution outlet(s) 18, gradually increasing the pressure of the chamber to approximately 1-15 Pa (25-75 mTorr). Normally, in order to maintain a suitable gas pressure of a desired gas composition and to flush out contaminants in the deposition chamber 10, a steady flow of clean argon gas is maintained. The gas may be added to the deposition chamber 10 from a plurality of gas distribution outlets 18, which are spaced at strategic locations within sputtering chamber. This helps ensure a uniform gas composition and distribution across the surface of target 12. This, in turn, helps ensure a relatively uniform film 22 deposited on substrate 20, which will thereby be free from any visible variations in thickness or composition.

Once gas has been introduced to the deposition chamber 10 the power source administers a positive charge to anode and a negative charge to the cylindrical target 12. As previously mentioned, the administration of charge to the cathode and anode generates a plasma, which facilitates the sputtering of target material from the target 12 to the substrate 20. Generally, the substrate 20 is passed through the chamber by a roller support 24 at a predetermined rate. The rate may be adjusted to provide the desired exposure to sputtered target material, thereby forming a coating of the preferred thickness.

As previously suggested, the deposition chamber 10 of the present invention is adapted to maintain a controlled environment, e.g., temperature, pressure, and vacuum. The chamber is a plenum chamber; a compartment in which the interior air pressure is higher than the exterior air pressure. Gas is forced into the chamber and then slowly dispersed through an exhaust port. A vacuum source, e.g. vacuum pump, is connected to the deposition chamber as shown in FIGS. 1 & 2 to evacuate deposition chamber 10 and maintain the interior of deposition chamber 10 at the appropriate vacuum level. The vacuum may be provided through the same line used for the dry air distribution system, as shown in FIG. 1, or it may have its own separate line, as shown in FIG. 2. Preferably, the deposition chamber 10 includes external ducts (not shown) to circulate a coolant (e.g., liquid coolant) in order to maintain the internal temperature of the chamber and minimize outgassing of the walls during sputter deposition.

While only a few preferred embodiments of the present invention have been described, it should be understood that various changes, adaptations and modifications may be made therein without departing from the spirit of the invention and the scope of the appended claims.

What is claimed is:

1. A method of decontaminating a deposition chamber, comprising the steps of:
preparing dried air by removing moisture from a quantity of air,
blowing the dried air into the deposition chamber, and
withdrawing humid air from the deposition chamber after it has absorbed a portion of the moisture present within the deposition chamber.

2. The method of claim 1, wherein the air pressure within the deposition chamber is maintained above atmospheric pressure.

3. The method of claim 1, wherein the dried air blown into the deposition chamber has a temperature of 75° F. or more.

4. The method of claim 3, wherein the dried air blown into the deposition chamber has a temperature between about 90° F. and about 150° F.

5. The method of claim 1, wherein the dried air has a dew point of −20° F. or less.

6. The method of claim 5, wherein the dried air has a dew point of −55° F. or less.

7. The method of claim 1, wherein the dried air is blown in and humid air is withdrawn continuously during decontamination.

8. The method of claim 1, wherein the deposition chamber is a magnetron sputtering deposition chamber.

9. The method of claim 1, wherein the step of preparing dried air comprises the steps of removing moisture from the air by refrigerator condensation, and by passing the air through a desiccant material.

10. The method of claim 1, wherein the dried air is blown into the deposition chamber at a rate of 500 scfm or more.

11. A deposition chamber decontamination system comprising a desiccation system operatively connected to a deposition chamber and including a blower that directs dried air from the desiccation system into the deposition chamber.

12. The deposition chamber decontamination system of claim 11, wherein the desiccation system comprises a cooling coil condenser and a desiccant dehumidifier.

13. The deposition chamber decontamination system of claim 12, wherein the desiccant dehumidifier utilizes a solid desiccant that is reactivated by hot dry air after absorption of moisture.

14. The deposition chamber decontamination system of claim 11, wherein the deposition chamber decontamination system comprises one or more heaters that raise the temperature of the dried air blown into the deposition chamber to 75° F. or more.

15. The deposition chamber decontamination system of claim 13, wherein a heater is operatively connected to the desiccant dehumidifier, such that air blown through the heater provides hot dry air that reactivates the solid desiccant and is thereby converted to moist exhaust air.

16. The deposition chamber decontamination system of claim 15, wherein the moist exhaust air is directed to a heat exchanger that releases generated heat within the deposition chamber decontamination system.

17. The deposition chamber decontamination system of claim 11, wherein the deposition chamber is operatively connected to a vacuum source.

18. The deposition chamber decontamination system of claim 17, wherein the desiccation system and the vacuum source are independently connected to the deposition chamber.

19. A system for decontaminating a magnetic sputtering deposition chamber, comprising a desiccation system operatively connected to a deposition chamber and including a blower that directs dried air from the desiccation system into the deposition chamber, the desiccation system comprises a cooling coil condenser and a desiccant dehumidifier utilizing a solid desiccant, and further comprising a desiccant reactivation system comprising a heater that reactivates a portion of the solid desiccant, thereby forming moist exhaust air that is withdrawn from the desiccant reactivation system by a blower, and a vacuum source operatively connected to the deposition chamber.

20. The system of claim 19, wherein the moist exhaust air is directed to a heat exchanger that releases generated heat into an airstream leading to the heater of the desiccant reactivation system.

21. The system of claim 19, wherein the dried air flows into the deposition chamber at a rate of 500 scfm or more, has a dew point of −20° F. or less, and a temperature of between about 90° F. and about 150° F.
